(19) United States
(12) Patent Application Publication
(10) Pub. No.: US 2006/0209328 A1
(43) Pub. Date: Sep. 21, 2006

(54) Systems and methods that facilitate selective enablement of a device driver feature(s) and/or application(s)

(75) Inventors: Eric R. Anderson, Issaquah, WA (US); George E. Roussos, Seattle, WA (US); Jon M. Morris, Mukilteo, WA (US); Eugene S. Lin, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/080,856

(22) Filed: Mar. 15, 2005

(51) Int. Cl. G06F 3/12

(52) U.S. Cl. 358/1.13; 358/1.15

(57) ABSTRACT

The subject invention relates to enabling device drivers that support additional functionality that can be enabled to an operating system. A hardware manufacture can claim support for additional functionality in their device drivers, and such functionality can be verified and tagged during driver signing. When a device driver passes a corresponding test, the driver is digitally signed and the signature can include attributes indicating support for that functionality (e.g., features and applications). The systems and methods employ a querying mechanism that can search a device driver package for attributes and expose such attributes. The search can expose both trusted attributes and untrusted device driver properties. Exposed trusted attributes can be selectively enabled to provide corresponding features and/or applications. This can facilitate enabling aspects of hardware when corresponding drivers support such functionality and mitigate enabling an unsupported feature and/or an application. Untrusted properties can be manually enabled, for example, for testing purposes.

### TECHNICAL FIELD

The subject invention generally relates to computers, and more particularly to systems and methods that facilitate enabling device driver features and/or applications by exposing attributes that reveal supported functionality.

### BACKGROUND OF THE INVENTION

Microprocessor-based devices have evolved into reliable and pervasive tools that facilitate everyday common tasks (e.g., microwave cooking, automobile ignition systems, entertainment centers . . . ), complex mathematical computations (e.g., trending, controlling a robot, forecasting . . . ), sophisticated applications (e.g., business workflow, word-processing, financial logging, electronic mail . . . ), etc. Such devices typically include one or more processors and various types of memory as well as other components that enable efficient and robust multi-tasking. Incremental advances in electronics, networking and software technologies have resulted in reduced device production costs that have correlated to decreased consumer purchasing costs, which has rendered computers (e.g., desktop, laptop, handheld . . . ) essentially ubiquitous throughout many portions of the world.

As computing devices have become more widespread, peripherals associated with such devices have also become commonplace. For instance, a typical computing device includes a plurality of ports (e.g., serial, parallel, USB, PS/2, network . . . ) into which peripherals can be attached and utilized in connection with the computing device. More particularly, attachable peripherals can include printers, keyboards, portable music/video players and recorders, cameras, video cards, speaker systems, personal digital assistants (PDAs), portable telephones and/or one or more other known peripherals. These peripherals can be physically coupled to the computing device through ports and/or can be communicatively coupled over a wireless link. This interaction of peripherals with computing devices has rendered such computing devices even more valuable in terms of user efficiency.

Peripherals typically are associated with an identification number or sequence that uniquely identifies the type of hardware. For instance, a sequence of bits, a name, a serial number, or the like can be employed to uniquely identify the type of hardware. In general, when hardware is added to a computing system, the hardware is identified through an associated ID, which is utilized to locate one or more device drivers for installation. The appropriate device driver(s) is loaded to enable utilization of the hardware within an operating system. In general, a device driver is a program that controls and/or regulates a particular type of hardware device that is attached to a computing system. It essentially converts more general input/output instructions of an operating system to messages that the device type can understand. Thus, a driver can act as a translator between the device and one or more programs that use the device.

Respective devices typically are associated with a set of specialized commands that only its device driver knows. In contrast, most programs access devices by using generic commands. A device driver can accept such generic commands from a program and translate them into specialized commands for the device. Thus, the operating system does not have to understand and support the needs of individual hardware devices. In many instances, a device driver can be implemented as a virtual device driver. Generally, there can be a virtual device driver for each main hardware device in the system, including a hard disk drive controller, a keyboard, a serial port, and a parallel port, for example. These drivers are utilized to maintain a status of a hardware device that has changeable settings. Virtual device drivers often handle software interrupts from the system rather than hardware interrupts.

As briefly noted above, device drivers are utilized to control peripheral devices attached to a computing system. Such peripheral devices include, but are not limited to, printers, keyboards, displays, CD-ROMs, disk drives, video adapters, network cards, sound cards, local buses, mice, USB, file systems, image scanners, digital cameras, etc. In many instances, one or more device drivers for a type of device are built into or are included with the operating system. For instance, device drivers for keyboards typically are included with the operating system. When a keyboard is connected to the computing system, suitable device drivers are selected and installed with the keyboard. However, when a new type of device that was not anticipated during operating system development (e.g., did not exist at the time of the release of the operating system) new device drivers are installed with the device. In another example, the device drivers included in the operating system can become outdated such that newer versions are required for proper operation of the device. In many instances new drivers are provided with the device and/or are downloaded from distributor's web or FTP site. Such drivers can be identified (e.g., via a path to a location on a disk and browsing the disk) and employed during installation. In yet another example, a vendor may release an updated version of device drivers for an existing device that is already connected to and actively operating within a computing system. The updated version may correct deficiencies and/or leverage new operating system features.

Device drivers typically are packaged within a device driver package. Such packages can include an information file (e.g., INF) that associates and installs one or more device drivers with hardware. The device driver package typically includes the one or more device drivers. In many instances, a device installation application is provided with the hardware device to install the device drivers from the device driver package. Such application can be utilized to install the device and corresponding information file and device drivers. The operating system typically provides a device driver interface, which generally is a set of functions that are implemented by the operating system for utilization by the device drivers.

Conventionally, an operating system manufacturer provides a list of device driver related requirements that a hardware manufacturer must meet in order for their device to properly install and operate under the operating system. When such requirements are met (e.g., through testing, verification, validation . . . ), the hardware manufacturer can obtain a digital signature for a corresponding device driver package. For example, the device manufacturer can submit a log of all testing as evidence that the device drivers satisfy the requirements and a certifying body can digitally sign the driver package. During installation, the signed device driver package is utilized to install suitable device drivers for the hardware. This approach does not provide granularity to indicate additional features and/or applications supported by the drivers.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The subject invention relates to systems and methods that facilitate identifying and exposing device drivers that support additional functionality, and selectively enabling at least one associated feature and/or application to an operating system. Conventionally, device drivers need to be signed in order to be installed within an operating system. Device manufacturers can employ driver signing programs to test their drivers against operating system hardware requirements, wherein drivers that satisfy the requirements are deemed compliant and digitally signed. During installation, the signed device driver package is utilized to install suitable device drivers for the hardware. This signature does not provide granularity that defines additional features and/or application supported by the device drivers. In addition, outside of install time the device driver package does not affect the features supported by the operating system. The systems and methods of the subject invention provide novel extensions, wherein hardware manufacturers can claim support for additional functionality in their device drivers, and such functionality can be verified and tagged during driver signing. When a device driver passes a corresponding test, the driver is digitally signed, wherein the signature includes attributes indicating support for the additional functionality (e.g., OS features and/or applications). The operating system can then query the signature attributes at any time (e.g., install and run-time) to ascertain supported features and/or applications and subsequently enable and/or disable any feature and/or application to the operating system. The foregoing facilitates enabling aspects of the hardware when the corresponding device drivers support such functionality. This can circumvent the operating system from enabling an unsupported feature and/or an application, which commonly results in a poor end-user experience.

In one aspect of the invention, a device driver manger is provided that facilitates exposing and enabling at least one device driver supported feature and/or application. This manager can scrutinize a device driver package for one or more device driver attributes that reveal a set of functionality supported by the corresponding device. These attributes can be mapped to the associated functionality and one or more supported features and/or applications corresponding thereto can be enabled to the operating system when such features and/or applications are supported by the device drivers.

In another aspect of the invention, the device driver manager includes a query component that can search the device driver packages for supported features and/or applications. The query component can be, but is not limited to, an application programming interface (API) and the like. The query component can search through device driver packages, locate feature and/or application attributes, and/or expose such attributes. Exposed attributes can be mapped to respective functionality, and supported features and/or applications can be enabled if properly supported by the device drivers.

In yet another aspect of the invention, the device driver manager can include a decision-making component that can determine whether to enable any or all exposed features and/or applications. Where the decision-making component determines that a feature and/or application should be enabled, such feature and/or application can be automatically enabled. In another instance, a user can be prompted as to whether the OS feature and/or application is enabled. In yet another instance, intelligence can be employed to determine and/or facilitate a user in determining whether the feature and/or application is enabled. Typically, only trusted attributes are automatically enabled.

In other aspects of the invention, methods are provided that facilitate enabling one or more additional device driver features and/or applications. In one instance, a method includes querying a device driver package for attributes associated with additional features and/or applications supported by the device drivers. The query can discover trusted and unstrusted attributes and expose such attributes. Trusted features and/or applications typically are automatically enabled, whereas untrusted features and/or applications can be manually enabled, for example, for testing device drivers. Another method provides for testing unsigned driver features and/or applications, for example, while under development. This method at least includes adding device driver properties to a device driver package, wherein the properties allow the features and/or applications to be enabled without a digital signature from a certifying agent of the operating system. Support for the features and/or applications can then be tested, wherein features and/or applications that pass the testing can be digitally signed.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates an exemplary system that facilitates exposing features and/or applications supported by device drivers.

FIG. 2 illustrates an exemplary system that employs a query component to locate signed attributes within a device driver package.

FIG. 3 illustrates an exemplary system that utilizes a decision-making component that determines whether to enable a feature and/or an application.

FIG. 4 illustrates an exemplary system that facilitates enabling device driver supported features and/or applications to an operating system.

FIG. 5 illustrates an exemplary system that tests hardware functionality associated with device driver properties.

FIG. 6 illustrates an exemplary system that employs intelligence to facilitate exposing and determining whether to enable a feature and/or application associated with signed and trusted attributes.

FIG. 7 illustrates an exemplary method for exposing and enabling device driver features and/or applications associated with trusted device drivers.

FIG. 8 illustrates an exemplary method for testing unsigned device drivers for support for features and/or applications.

FIG. 9 illustrates an exemplary method for tagging device driver packages with attributes for additional supported features and/or applications.

FIG. 10 illustrates an exemplary computing architecture that can be employed in connection with the subject invention.

FIG. 11 illustrates an exemplary networking environment that can be employed in connection with the subject invention.

### DESCRIPTION OF THE INVENTION

The systems and methods of the subject invention provide for exposing additional device driver functionality through attributes. In general, a hardware manufacture can claim support for additional functionality in their device drivers, wherein such functionality can be verified and tagged during driver signing. When a device driver passes a corresponding test, the driver is digitally signed and the signature includes attributes indicating support for that functionality. The systems and methods of the subject invention provide components that can query a device driver package and expose supported OS features and/or applications associated with such attributes and selectively enable one or more features and/or applications to the operating system. Such application, under proper conditions (e.g., where a trusted attribute is present) can enable relevant functionality.

Terms such as “component,” “manager,” and variations thereof are intended to refer to a computer-related entity, either hardware, a combination of hardware and software, software, or software in execution as applied to an automation system for industrial control. For example, a component may be, but is not limited to being, a process running on a processor, a processor, an object, an executable, a thread of execution, a program, a computer, and an industrial controller. By way of illustration, both an application running on a server and the server can be components. One or more components may reside within a process and/or thread of execution and a component may be localized on one computer and/or distributed between two or more computers (e.g., via data packets and signals between the computers), industrial controllers, and/or modules communicating therewith.

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

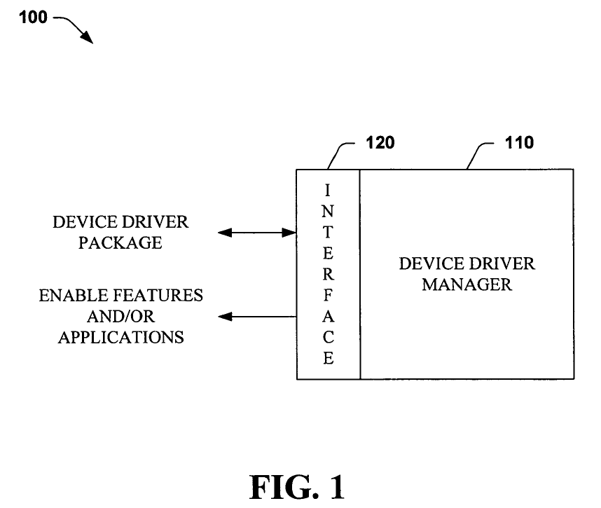

FIG. 1 illustrates a system 100 that facilitates exposing and enabling at least one device driver supported feature and/or application. The system 100 includes a device driver manager component 110 (“device driver manager 110”) that can scrutinize a device driver package for one or more device driver attributes that reveal a set of functionality supported by the corresponding device. For example, the device driver manager component 110 could detect a signed display device driver that supports DirectX and/or VMR and has an attribute for Aero Glass. The device driver manager 110 can expose the Aero Glass attribute and enable Aero Glass to the operating system. In many instances, enabling such features and/or applications can enhance a user's experience.

Conventionally, device drivers are packaged, tested and signed if the package passes the testing. A signed device driver package can be utilized during installation of corresponding hardware. The operating system manufacturer typically provides the requirements and/or posts the requirements for device manufactures. A device manufacturer utilizes the requirements to develop hardware and associated device drivers that comply with the operating system. In some instances, the operating system manufacture provides a device driver testing tool to the device manufacturer to test device drivers. Device driver packages with device drivers that satisfy the requirements, or pass the corresponding tests, are deemed compliant and are digitally signed. During installation, the signed device driver package (which typically includes an information file (e.g., INF) that facilitates installation) is utilized to install suitable device drivers for the hardware.

The subject invention provides for greater device driver functionality granularity and run-time feature and/or application enablement decision making. For example, rather then simply installing device drivers from a signed device driver package, the device driver manager 110 can scrutinize the device driver package for one or more attributes that respectively indicate additional features and/or applications supported by the device drivers. This additional information can be leveraged by the device driver manager 110 during install and/or run-time to selectively enable one or more additional features and/or applications supported by the device drivers. Thus, the device driver manager 110 can enable features and/or applications based on functionality supported by the device drivers as well as the configuration of the operating system and the computing system.

In general, hardware typically is associated with an identification such as a hardware ID. This ID is associated with a device driver package, which commonly includes at least an information file (e.g., INF) that associates and facilitates installation of one or more device drivers with the hardware and the corresponding device drivers. In accordance with the subject invention, if a device driver satisfies operating system requirements (e.g., passes an associated test criteria), a digital signature is applied to the device driver and associated with the information file. In addition, the digital signature is associated with each attribute that corresponds to an OS feature and/or application that passes an associated test. The device driver manager 110 can discover such attributes and selectively enable associated features and/or applications. In other aspects of the invention, the device driver manager 110 can also discover unsigned attributes. Typically, features and/or applications associated with these attributes are not automatically enabled. In some instances, unsigned attributes can be manually enabled, for example, for testing purposes.

The system 100 further includes an interface component 120 (“interface 120”), which provides various adapters, connectors, channels, communication paths, etc. to integrate the device driver manager 110 into virtually any operating system. In addition, the interface 120 can provide various adapters, connectors, channels, communication paths, etc. that provide for interaction with device driver packages.

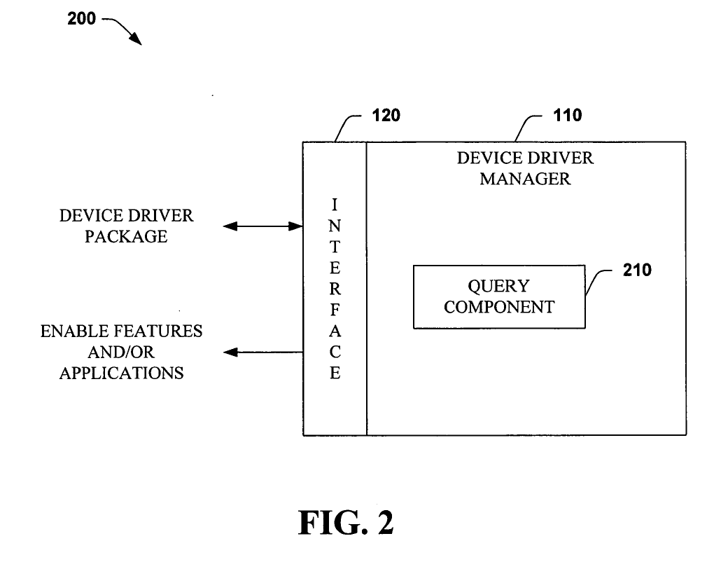

FIG. 2 illustrates a system 200 that employs a query component to search a device driver package for feature and/or application attributes. The system 200 includes the device driver manager 110 and the interface 120, and further includes a query component 210. The device driver manager 110 utilizes the query component 210 to search through device driver packages, locate feature and/or application attributes, and/or expose such attributes. Exposed attributes can be mapped to respective functionality, and supported features and/or applications can be enabled if properly supported by the device drivers.

The query component 210 can be, but is not limited to, an application programming interface (API) and the like. In general, an API can define how pieces of computer software can communicate with one another. It can provide a mechanism of achieving an abstraction, for example, between lower-level and higher-level software. The query component 210 can provide for programmatic querying over device driver packages. As noted previously, a device driver package as defined herein can include at least an information file that associates and installs one or more device drivers with the hardware, one or more associated device drivers, and attributes that indicate additional features and/or applications supported by the device drivers. In addition, and as discussed in detail below, the device driver package can include device driver properties manually incorporated by a user. Where the device driver package satisfies operating system requirements, respective device drivers and attributes can be digitally signed. Such signature can deem respective device drivers and/or attributes as “trusted.” In general, a “trusted” attribute is defined as a tested attribute that satisfies a set of tests and is signed by a user with suitable privileges (e.g., a publisher, an author, an administrator, a certifying agency . . . ). An “untrusted” attribute can refer to an attribute that has not been tested against associated requirements, an attribute that has failed such test, an attribute associated with a device driver and/or a device driver package that has failed testing, and/or an attribute signed by a party that is not authorized by the operating system manufacturer.

The query component 210 can be invoked by the device driver manager 110 to search one or more device driver packages. The device driver package can be provided to the device driver manager 110 and searched by the query component 210, retrieved by the query component 210, and/or stored in a location that can be accessed (e.g., read) by the query component 210. It is to be appreciated that the device driver package can be stored on essentially any storage medium such as, but not limited to, local memory (e.g., cache, RAM, hard disk . . . ), portable memory (e.g., CompantFlash, memory stick, CD, DVD, Optical Disk, Tape . . . ), and/or remote memory (e.g., a server, a database, a different computing system, a web site, an FTP site . . . ).

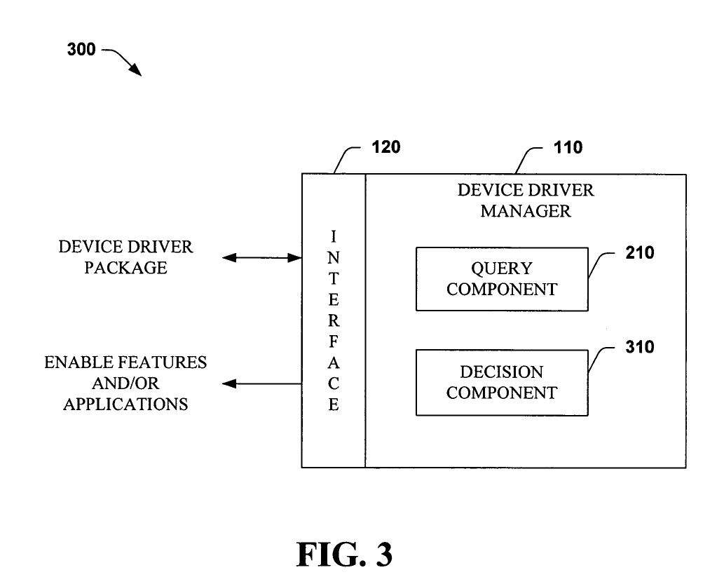

FIG. 3 illustrates a system 300 that employs a decision making component to determine whether a feature and/or an application associated with an attribute in a device driver package should be enabled. The system 300 includes the device driver manager 110, which can execute in connection with an operating system and interact with device driver packages. The system 300 further includes the interface 120, which provides various communication schemes that facilitate interaction with the device driver manager 110, and the query component 210, which can search device driver packages and locate attributes therein that signify additional supported features and/or applications. The query component 210 can also determine whether an attribute is trusted or untrusted and expose such attributes.

The system 300 further includes a decision-making component 310 that can determine whether to enable any or all exposed features and/or applications. Where the decision-making component determines that a feature and/or application should be enabled, such feature and/or application can be automatically enabled. Such decision can be based at least in part on supported features and/or applications, an operating system, device drivers included with the operating system, a computing device executing the operating system, one or more users with accounts on the computing device, etc. In other aspects of the invention, a user can be prompted as to whether the feature and/or application is enabled and/or intelligence (e.g., machine learning, artificial intelligence . . . ) can be employed to determine and/or facilitate a user in determining whether the feature and/or application is enabled. Typically, only trusted attributes are automatically enabled. Untrusted attributes can be discovered and exposed; however, they typically are not enabled. Such attributes can be manually enabled, for example, for testing purposes.

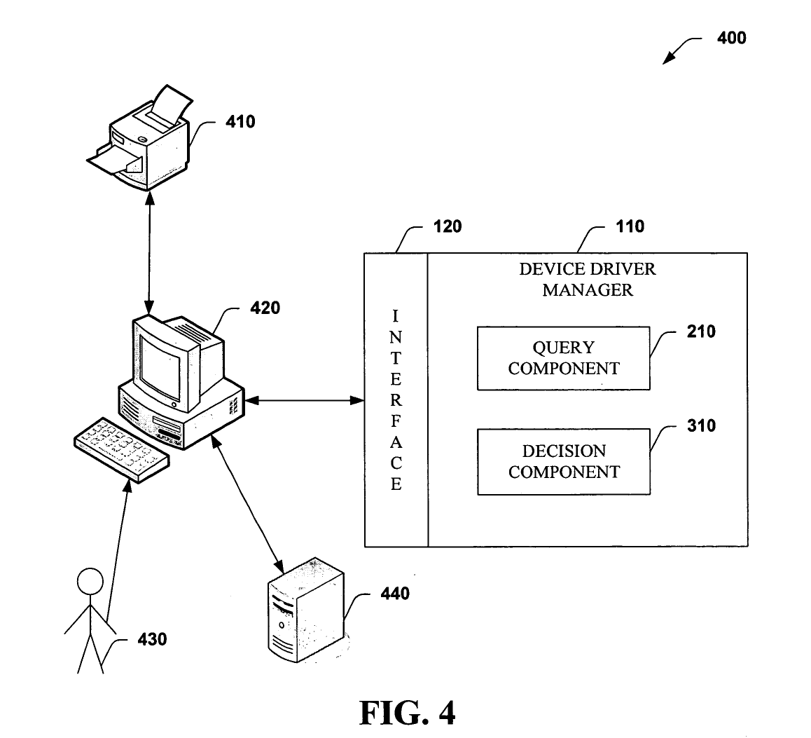

FIG. 4 illustrates a system 400 that employs the device driver manager 110 to facilitate enabling one or more device driver supported features and/or applications. In this example, a printer 410 is connected to a computing device 420. However, it is to be appreciated that various other hardware can be connected to the computing device 420 and that essentially any type (e.g., a computer as depicted, a state machine . . . ) of computing device can be employed. The query component 210 can be invoked to search an associated device driver package for attributes. Such attributes can be associated with supported features and/or applications, validated, and/or digitally signed as trusted. The device driver package can be provided by and/or obtained from a user 430 and/or a store 440, and/or saved locally to the computing device 420. Discovered attributes can be exposed by the query component 210, and the decision-making component 310 can determine whether to enable any exposed feature and/or application associated with trusted attributes.

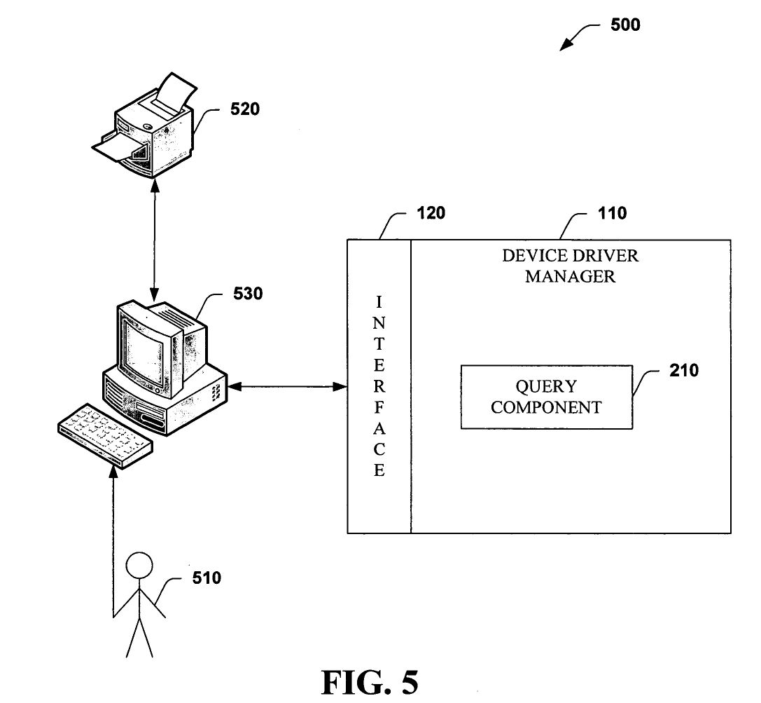

In general, unsigned device drivers, with or without attributes, will not be automatically installed. However, an administrator or other person with suitable privileges can generate a signature for such device drivers, for example, digitally sign the device driver. In addition, a test signature can be obtained from the operating system manufacturer. It is to be appreciated that unsigned device drivers and associated attributes can be found and exposed by the query component 210. The user 430 can add device drivers properties to an unsigned package of device drivers (e.g., as described in detail in connection with FIG. 5) for testing purposes. Such properties enable operating system features and/or applications to be installed for testing purposes. In many instances, when enabling OS features and/or applications associated with such device driver properties, the attribute is deemed not trusted since the device drivers are not tested and signed as trusted by an authorizing agent of the operating system. After testing, the driver package and test results can be submitted to an appropriate certifying authority to obtain a signature.

It is to be understood that not all signed device driver packages, device drivers and/or feature and/or application attributes are trusted. A device driver package may be signed; however, if the signer is not an approved signer of the operating system, the operating system features and/or application associated with attributes may not be automatically signed. Rather, in one instance, such OS features and/or applications can be found and exposed, and suitable tests for trusting these OS features and/or applications can be identified and subsequently utilized to test the device drivers for support. In another instance, such OS features and/or applications can be manually enabled. Associated device drivers can then be tested and subsequently signed if they pass the tests.

FIG. 5 illustrates a system 500 that tests hardware functionality through manually set device driver properties. A third party user 510 can indicate support in a device driver package for additional capabilities by including one or more device driver properties in an associated information file (e.g., INF). As depicted, the third party user 510 can add device properties for a printer 520 to an associated device driver package. It is to be understood that the system 500 can be employed in accordance with essentially any hardware. The third party user 510 can add one or more device driver properties to the information file associated with the printer 520 device driver package. Such device driver properties typically are not considered as trusted attributes by the operating system since they have not been validated and are not signed by an authorizing agent. As a consequence, the device driver properties typically would not be utilized to determine whether a feature and/or application is enabled. Regardless, the query component 210 of the device driver manager 110 can be utilized to query the device driver package and expose the features and/or applications associated with the device driver properties. In one instance, an appropriate set of tests can be identified, wherein such test can be utilized to test the features and/or applications against operating system requirements. If the results of the tests indicate the requirements are met, the features and/or applications can be signed. In another instance, a user can manually enable and/or sign the features and/or applications, if they satisfy the requirements.

The foregoing can be leveraged during pre-release testing (e.g., during development, alpha testing, beta testing . . . ), wherein the third party user 510 can set the device driver properties for the printer 520 to allow for installation of device drivers properties in connection with an operating system of a computing system 530 for testing purposes. By including device driver properties in the device driver package, the third party user 510 can manually indicate support for a particular operating system feature and/or application, and then install and test one or more device drivers without a test digital signature. In another instance, the user 510 can obtain a test digital signature to utilize during testing. Upon completion of testing, the results can be forwarded to an appropriate signing facility for a digital signature. Additionally, the third party user 510 can utilize the query component 210 of the device driver manager 110 to query device driver packages for specific functionality required by an application. For instance, if a next version of a game relied on trusted features, the game could optimize its settings based on the device driver support associated with the feature, which can provide an enhanced user experience.

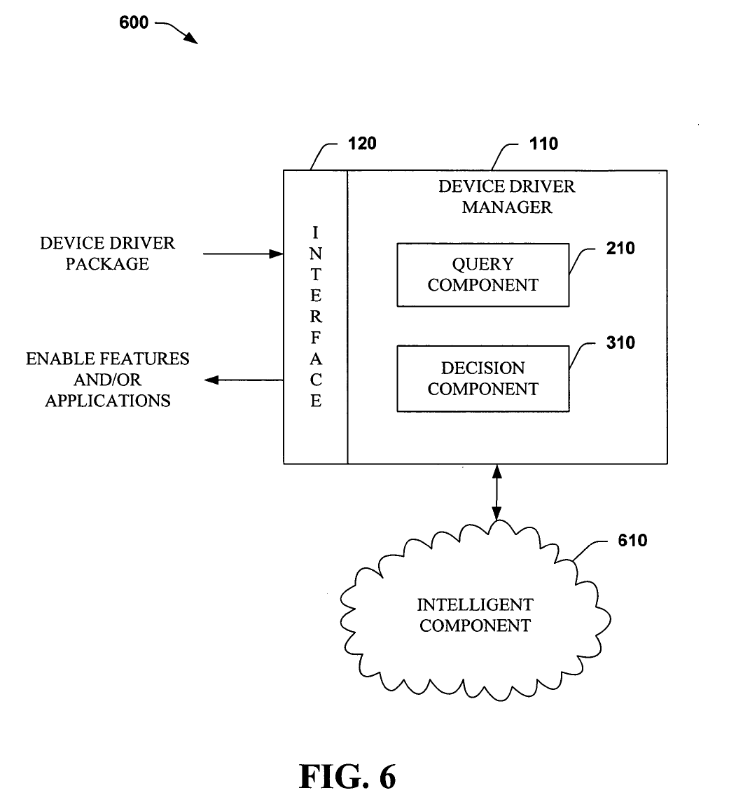

FIG. 6 illustrates a system 600 that employs intelligence to facilitate discovering and determining whether to enable a feature and/or application associated with signed and trusted attributes. The system 600 includes the device driver manager 110 with the query component 210 and the decision component 310. As described in detail above the device driver manager 110 can be employed in connection with essentially any operating system to facilitate enabling features and/or applications associated with a signed and trusted device driver attribute. Such attributes can be located by the query component 210 by searching a corresponding device driver package and exposing them to the device driver manager 110. The decision component 310 can then determine whether to enable any and/or all of the exposed features and/or applications. Where the decision component 310 determines that a feature and/or application should be enabled, such feature and/or application can be automatically enabled.

The system 600 further includes an intelligent component 610. The intelligent component 610 can be utilized by the device driver manager 110, the query component 210 and/or the decision component 310 to facilitate them with respective functions. For example, the intelligent component 610 can be utilized to facilitate integrating the device driver manager 110 with an operating system. For example, a computing system may have more than one operating system. The intelligent component 610 can determine which operating system is a currently active operating system and employ suitable protocols, interfaces, etc. In another instance, the query component 610 can utilize the intelligent component 610 to locate a device driver package and/or search a device driver package for attributes. In yet another instance, the decision-making component 310 can employ the intelligent component with rendering a decision as to whether to enable a feature and/or application.

It is to be understood that the intelligent component 610 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the subject invention.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

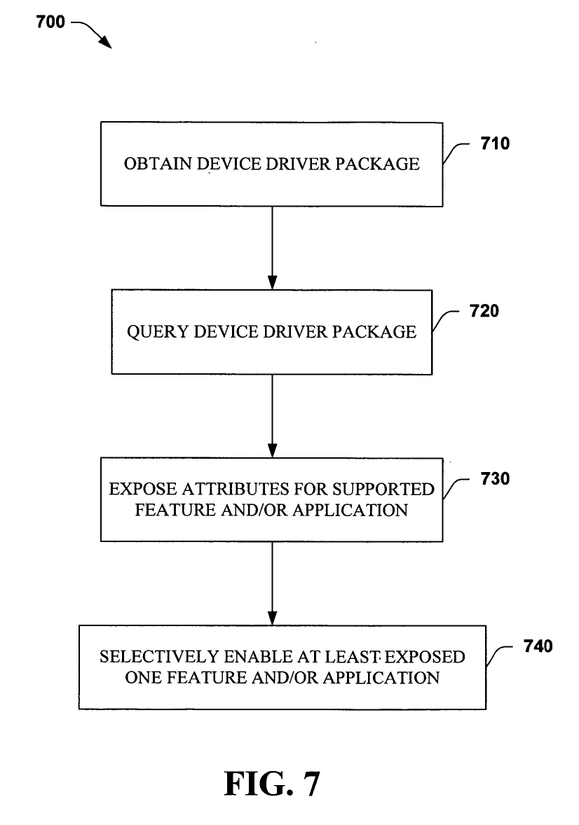

FIGS. 7-9 illustrate methodologies, in accordance with an aspect of the present invention. While, for purposes of simplicity of explanation, the methodologies are shown and described as a series of acts, it is to be understood and appreciated that the present invention is not limited by the order of acts, as some acts can, in accordance with the present invention, occur in different orders and/or concurrently with other acts from that shown and described herein. For example, those skilled in the art will understand and appreciate that one or more of the methodologies could alternatively be represented as a series of interrelated states or events, such as in a state diagram. Moreover, not all illustrated acts may be required to implement the methodologies in accordance with the present invention.

FIG. 7 illustrates a method 700 for exposing and enabling device driver features and/or applications associated with trusted device drivers. At reference numeral 710, a device driver package for hardware connected to a computing system is obtained. Such hardware typically is associated with an identification such as a hardware ID. This ID can be associated with the device driver package, which commonly includes at least an information file (e.g., INF) that associates and facilitates installation of one or more device drivers with the hardware and the corresponding device drivers. At 720, the device driver package is queried for attributes associated with additional features and/or applications supported by the device drivers. -The query can discover trusted and unstrusted attributes and expose such attributes. In general, if a device driver satisfies operating system requirements (e.g., passes associated testing), a digital signature that indicates trust is applied to the device driver and/or the information file. In addition, the digital signature can be associated with each attribute that corresponds to the feature and/or application that passes an associated test. At 730, the attributes can be exposed to reveal the features and/or application supported by the device drivers. At reference numeral 740, features and/or applications can be selectively enabled. Typically, trusted features and/or applications are automatically enabled, whereas untrusted features and/or applications can be manually enabled. Manual enablement of unstrusted features and/or applications commonly is utilized for testing device drivers.

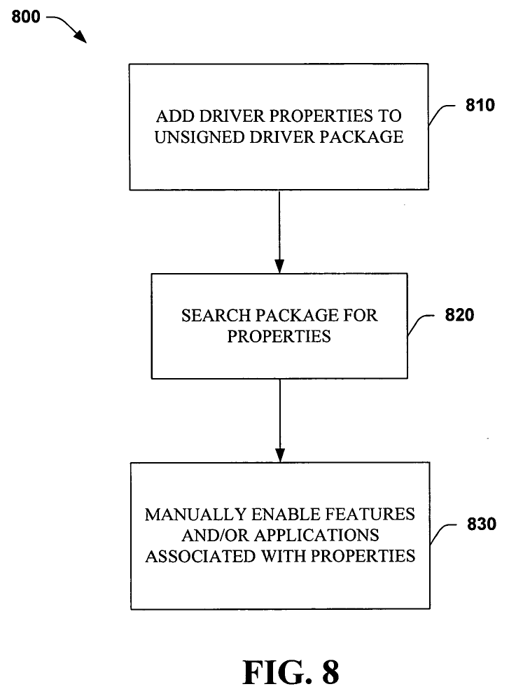

FIG. 8 illustrates a method 800 for testing unsigned device drivers for support for one or more features and/or applications. At 81 0, device driver properties can be added to an unsigned device driver package. Such properties can be associated with an information file (e.g., INF) and related to features and/or applications. It is to be appreciated that one or more device driver properties can be included in the device driver package. Such untrusted device driver properties typically are not utilized to determine whether a feature and/or application is enabled. At 820, the device driver package can be searched for such properties, wherein discovered properties can be exposed. At reference numeral 830, at least one feature and/or application can be enabled. Typically, manual enablement of untrusted device driver properties is utilized during testing of such features and/or applications. The foregoing can be leveraged during pre-release testing (e.g., during development, alpha testing, beta testing . . . ), wherein a party can set the device driver properties to allow for installation of the device. The device drivers associated with the device can then be tested, wherein test results and the driver package that passed the test can be submitted for a digital signature. Furthermore, the party can query a device driver package for specific functionality required by an application. For instance, if a next version of a game relied on trusted features, the game could optimize its settings based on the device driver support associated with the feature, which can provide a higher experience for devices that properly supported it. Moreover, the party can obtain a test signature, which can be utilized for testing feature and/or application support associated with a device driver package.

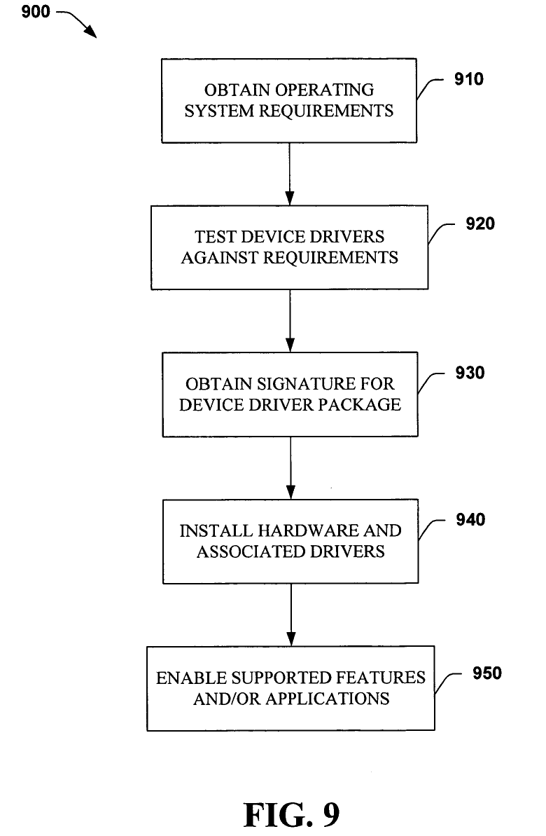

FIG. 9 illustrates a method 900 for tagging device driver packages with attributes for additional supported features and/or applications. At reference numeral 910, operating system requirements are obtained. Such requirements can be utilized by developers to develop device drivers that are compliant with the operating system. The device drivers can be package along with an information file that facilitates installation and attributes that indicate support for additional features and/or applications. At reference numeral 920, the device drivers can be tested against the requirements. Such testing can be through test tools provided by the operating system manufacturer, for example. At 930, device driver packages with device drivers that satisfy the requirements, or pass the corresponding tests, are deemed compliant and are digitally signed. In addition, the attribute associated with a digital signature that corresponds to feature and/or application that passes an associated test. At 940, the device is installed. During installation, the device driver package is queried for attributes and discovered features and/or applications associated with the attributes are exposed. At reference numeral 950, the exposed features and/or applications can be selectively enabled.

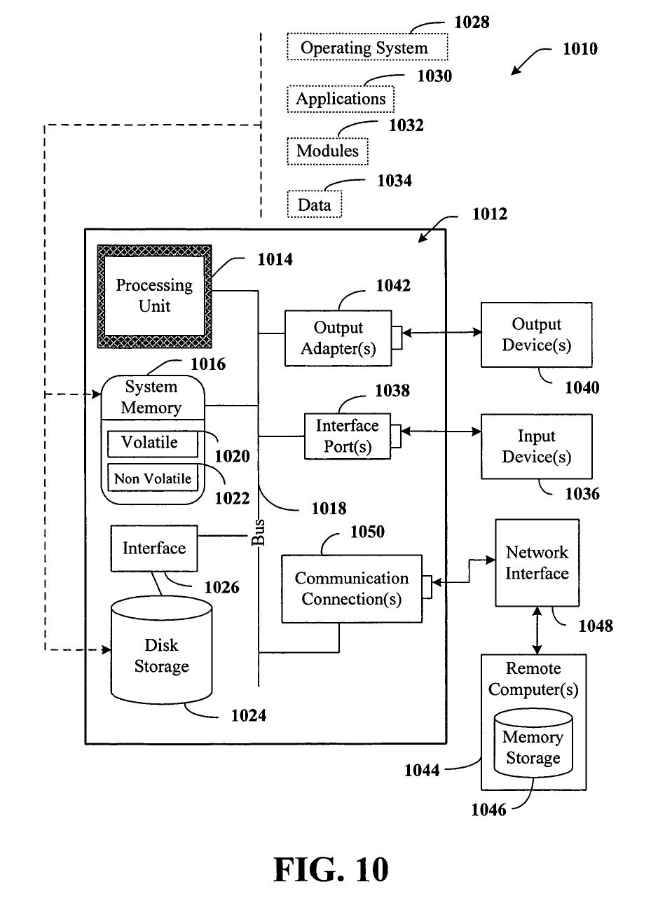

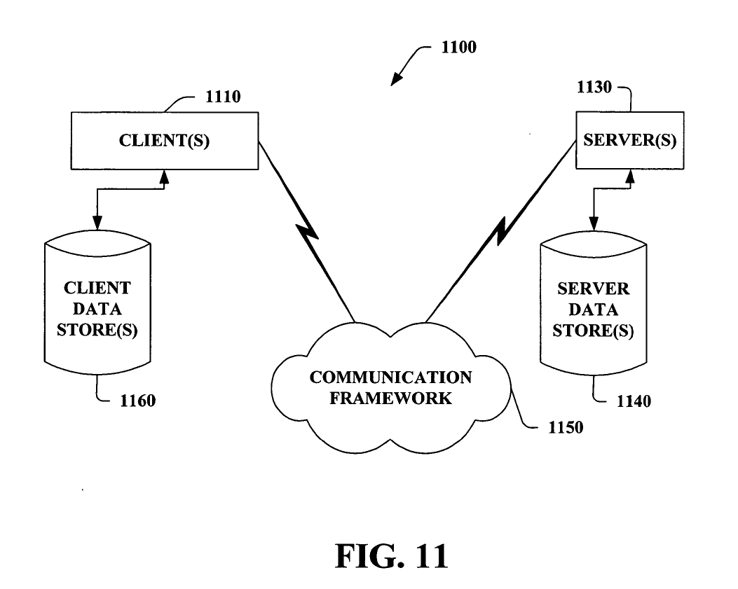

In order to provide a context for the various aspects of the invention, FIGS. 10 and 11 as well as the following discussion are intended to provide a brief, general description of a suitable computing environment in which the various aspects of the present invention can be implemented. While the invention has been described above in the general context of computer-executable instructions of a computer program that runs on a computer and/or computers, those skilled in the art will recognize that the invention also can be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention may also be practiced in distributed computing environments where task are performed by remote processing devices that are linked through a communications network. However, some, if not all aspects of the invention can be practiced on stand-alone computers. In a distributed computing environment, program modules may be located in both local and remote memory storage devices.

With reference to FIG. 10, an exemplary environment 1010 for implementing various aspects of the invention includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 10-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and Rambus Direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the present invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012 and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

FIG. 11 is a schematic block diagram of a sample-computing environment 1100 with which the present invention can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the present invention, for example. One possible communication between a client 1110 and a server 1130 can be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

What has been described above includes examples of the present invention. It is not possible to describe every conceivable combination of components or methodologies for purposes of describing the present invention, but one of ordinary skill in the art may recognize that many further combinations and permutations of the present invention are possible. Accordingly, the invention is intended to embrace all such alterations, modifications, and variations that fall within the spirit and scope of the appended claims. In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention. In addition, while a particular feature of the invention may have been disclosed with respect to only one of several implementations, such feature may be combined with one or more other features of the other implementations as may be desired and advantageous for any given or particular application.

What is claimed is:

1. A system that facilitates discovering and selectively enabling features and/or applications supported by device drivers, comprising:
a component that receives a device driver package that includes at least one attribute that indicates one of an additional feature and an additional application that is supported by one or more device drivers in the device driver package; and
a decision-making component that automatically makes available to an operating system at least one of the supported feature and the supported application.

2. The system of claim 1, further comprising a query component that queries the device diver package for the at least one attribute.

3. The system of claim 1, the at least one attribute is one of trusted by the operating system and not trusted by the operating system.

4. The system of claim 2, the query component is an application programming interface (API).

5. The system of claim 1, the device driver package and the at least one attribute are signed by an authorizing agent of the operating system.

6. The system of claim 2, the query component further discovers at least one untrusted device driver property within the device driver package.

7. The system of claim 6, the at least one untrusted device driver property is added to the device driver package to at least one of develop and test the device driver for support for one of an unsigned feature and an unsigned application.

8. The system of claim 7, at least one of the unsigned feature and the unsigned application is manually enabled to the operating system by a user.

9. The system of claim 2, the query component searches the device driver package for the at least one trusted attribute during one of an install-time and a run-time.

10. The system of claim 1, the at least one attribute is associated with an information file within the device driver package, the information file associates and installs one or more device drivers with an associated hardware device.

11. The system of claim 1, the decision-making component disables at least one of the feature and the application during run-time.

12. A computer readable medium having stored thereon the components of the system of claim 1.

13. A method for enabling device driver supported features to an operating system (OS), comprising:
querying a device driver package for a feature that is supported by a device driver in the device driver package; and
automatically enabling the supported feature for use by the OS.

14. The method of claim 13, further comprising associating the feature with an attribute in the device driver package.

15. The method of claim 14, further comprising associating the attribute with an information file in the device driver package.

16. The method of claim 13, the attribute is signed and authenticated by a signing authority of the OS.

17. The method of claim 13, further comprising manually enabling an unsigned feature to test the device driver package to determine whether the device driver in the device driver package supports the unsigned feature.

18. The method of claim 13, further comprising enabling at least the supported feature in one of install-time and run-time.

19. The method of claim 13, further comprising disabling the supported feature during run-time.

20. A system that facilitates discovering and selectively enabling operating system (OS) features and/or applications supported by a device driver, comprising:
means for a searching a device driver package for an attribute that indicates one of a feature and an application that-is supported by one or more device drivers in the device driver package; and
means for automatically providing at least one of the supported feature and the supported application to an OS.
